(19) United States
(12) Patent Application Publication
(10) Pub. No.: US 2010/0103682 A1
(43) Pub. Date: Apr. 29, 2010

(54) LIGHT SOURCE MODULE

(75) Inventor: DA-WEI LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/502,372

(22) Filed: Jul. 14, 2009

(30) Foreign Application Priority Data
Oct. 24, 2008 (CN) 200810305180.9

(51) Int. Cl. F21V 7/00

(52) U.S. Cl. 362/307

(57) ABSTRACT

A light source module includes a light emitting component, a reflector and a transflective optical element. The reflector has a reflective surface, and the reflective surface defines a central axis. The light emitting component is arranged on the central axis of the reflector. The transflective optical element includes a light incident surface and a light emitting surface. The light incident surface faces the light emitting component and the reflector. The light emitting component is configured for emitting light. A first part of the light enters the transflective optical element through the light incident surface, and emits from the light emitting surface to a first central region. A second part of the light is reflected from the light incident surface to the reflective surface of the reflector, and then is reflected by the reflective surface of the reflector to a first peripheral region surrounding the first central region.

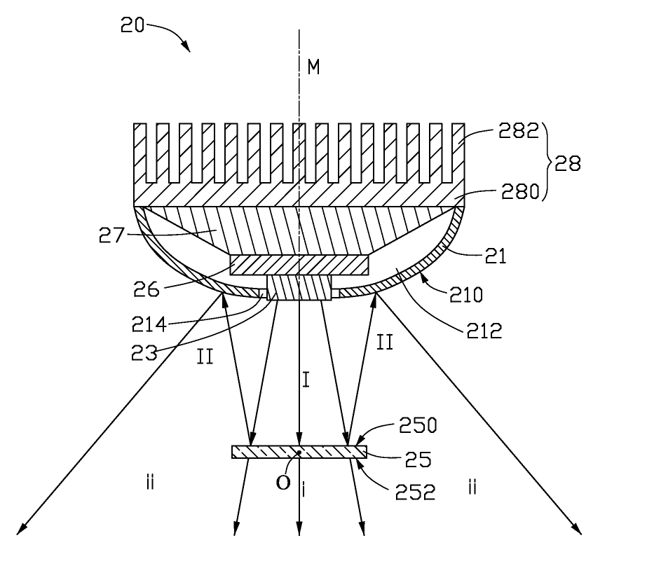

### BACKGROUND

1. Technical Field

The present relates to a light source module.

2. Description of Related Art

A light emitting diode (LED) emits light, thus forming a light field. Usually, a central portion of the light field has higher brightness than a peripheral portion of the light field surrounding the central portion. When the LED is directly coupled to a light guide plate to form a light source module, light emitted from the LED enters the light guide plate and exits from a light emitting surface of the light guide plate. Since the brightness of the light field formed by the LED is not uniform, brightness of the light emitting surface of the light guide plate may also be not uniform.

Therefore, a new light source module is desired to overcome the above-mentioned problem.

### BRIEF DESCRIPTION OF THE DRAWING

Many aspects of the embodiments can be better understood with references to the following drawing. The components in the drawing are not necessarily drawn to scale, the emphasis instead being placed upon clearly illustrating the principles of the present embodiments. Moreover, in the drawing, like reference numerals designate corresponding parts throughout the several views.

The drawing is a cross-sectional view of a light source module according to a present embodiment of the present disclosure.

### DETAILED DESCRIPTION

Embodiments will now be described in detail below with reference to the drawing.

Referring to the drawing, a light source module 20 according to an exemplary embodiment is shown. The light source module 20 includes a light emitting component 23, a reflector 21, a transflective optical element 25, a circuit board 26, a heat conductive plate 27, and a heat sink 28.

The reflector 21 has a reflective surface 210 defining a central axis M. The reflector 21 is arc-shaped in cross-section. The reflective surface 210 is configured for reflecting light incident thereon. The reflective surface 210 is a convex surface protruding towards the transflective optical element 25. In the present embodiment, the reflective surface 210 is a spherical surface. It should be noted that the reflective surface 210 can be an ellipsoidal surface, for example. The reflector 21 defines a through hole 214 and a receiving space 212 therein. The light emitting component 23 is received in the through hole 214. The light emitting component 23, the circuit board 26 and the heat conductive plate 27 are accommodated in the receiving space 212.

The light emitting component 23 can be a light emitting diode, for example. The light emitting component 23 is configured for radially emitting light towards the transflective optical element 25. The light emitting component 23 is disposed on the circuit board, e.g., a printed circuit board. The light emitting component 23 lies on the central axis M of the reflective surface 210.

The transflective optical element 25 includes a light incident surface 250 and an opposite light emitting surface 252. The light incident surface 250 faces the light emitting component 23 and the reflector 21. In the present embodiment, the transflective optical element 25 is a circular plate with a geometric center O, which falls on the central axis of the reflector 21.

The heat conductive plate 27 is sandwiched between the heat sink 28 and the circuit board 26, and is in thermal contact with both of them. The heat sink 28 includes a substrate 280 and a plurality of fins 282 protruding from the substrate 280.

In use, the light emitting component 23 emits light towards the transflective optical element 25, thus forming an optical field. In the optical field, a brightness of a first central region I is higher than that of a first peripheral region II surrounding the first central region I.

A first part of the light enters the transflective optical element 25 through the light incident surface 250, and emits from the light emitting surface 252 to a second central region i. A second part of the light is reflected from the light incident surface 250 to the reflective surface 210 of the reflector 21, and then is reflected by the reflective surface 210 of the reflector 21 to a second peripheral region ii surrounding the first central region i. Therefore, since a second part of the light is reflected from the light incident surface 250, light reaching the second central region i is less than light of the first central region I, and, accordingly, a brightness of the second central region i is lower than that of the first central region I. At the same time, since a second part of the light is reflected by the reflective surface 210 to the second peripheral region ii, light reaching the second peripheral region ii is more than light of the first peripheral region II. Therefore, a brightness of the second peripheral region ii is higher than that of the first peripheral region II. Accordingly, the brightness difference between the second central region i and the second peripheral region ii is decreased, thus forming a uniform optical field.

Furthermore, because the reflective surface 210 is a convex surface, the reflective surface 210 can reflect light to a wide range. As a result, the light source module 20 has a wide illumination range.

While certain embodiments have been described and exemplified above, various other embodiments from the foregoing disclosure will be apparent to those skilled in the art. The present invention is not limited to the particular embodiments described and exemplified but is capable of considerable variation and modification without departure from the scope of the appended claims.

What is claimed is:

1. A light source module comprising:
a light emitting component;
a reflector having a reflective surface, the reflective surface defining a central axis, the light emitting component being arranged on the central axis of the reflector; and
a transflective optical element comprising a light incident surface and a light emitting surface, the light incident surface facing the light emitting component and the reflector, the light emitting component being configured for emitting light towards the transflective optical element, wherein a first part of the light enters the transflective optical element through the light incident surface, and emits from the light emitting surface to a first central region, and a second part of the light is reflected by the light incident surface of the transflective optical element to the reflective surface of the reflector, and then is reflected by the reflective surface of the reflector to a first peripheral region surrounding the first central region.

2. The light source module of claim 1, wherein the reflective surface is a convex surface facing the tranflective optical element.

3. The light source module of claim 2, wherein the reflective surface is a spherical surface or an ellipsoidal surface.

4. The light source module of claim 1, wherein the reflector has a through hole defined therein, and the light emitting component is received in the through hole.

5. The light source module of claim 1, wherein the light source module further comprises a circuit board, and the light emitting component is mounted on the circuit board.

6. The light source module of claim 5, wherein the light source module further comprises a heat sink in thermal contact with the circuit board.

7. The light source module of claim 1, wherein the transflective optical element is a circular plate, and the central axis of the reflector passes a geometric center of the transflective optical element.
